(19) United States
(12) Patent Application Publication
(10) Pub. No.: US 2012/0061602 A1
(43) Pub. Date: Mar. 15, 2012

(54) FLAP, IN PARTICULAR THROTTLE FLAP, FOR INFLUENCING A VOLUMETRIC FLOW FLOWING IN A VENTILATION AND AIR-CONDITIONING SYSTEM

(76) Inventors: Lukas Zwiernik, Duisburg (DE); Daniel Leitner, Viersen (DE)

(21) Appl. No.: 13/229,890

(22) Filed: Sep. 12, 2011

(30) Foreign Application Priority Data
Sep. 10, 2010 (EP) 10176225.0

(51) Int. Cl. F16K 1/22

(52) U.S. Cl. 251/305

(57) ABSTRACT

The invention relates to a flap, in particular a throttle flap, for influencing a volumetric flow flowing in a ventilation and air-conditioning system. In order to specify a flap which has a simpler design and can additionally be produced and also mounted more easily, the intention is for the flap to be arranged in an installation frame having an opening and for the flap and the installation frame to form a mounting unit, wherein the flap is mounted in the opening such that it can pivot about a shaft or axle arranged centrally, in particular, with respect to the opening, and for the installation frame and the flap to each be produced from plastic.

### CROSS-REFERENCE TO RELATED APPLICATIONS AND CLAIM TO PRIORITY

This application is related to application number 10176225.0, filed Sep. 10, 2010 in the Federal Republic of Germany, the disclosure of which is incorporated herein by reference and to which priority is claimed.

### FIELD OF THE INVENTION

The invention relates to a flap, in particular a throttle flap, for influencing a volumetric flow flowing in a ventilation and air-conditioning system.

### BACKGROUND OF THE INVENTION

From experience, throttle flaps made of sheet metal are known, these being mounted by means of a separate shaft or axle in a ventilation duct of a ventilation and air-conditioning system such that they are mounted rotatably. The disadvantage here is that the design of such flaps is complex on account of the number of components, and the assembly and the mounting are also accordingly time-consuming.

### SUMMARY OF THE INVENTION

It is an object of the invention to avoid the aforementioned disadvantages and to specify a flap which has a simpler design and can additionally be produced and also mounted more easily.

This object is achieved in that the flap is arranged in an installation frame having an opening, and in that the flap and the installation frame form a mounting unit, wherein the flap is mounted in the opening such that it can pivot about a shaft or axle arranged centrally, in particular, with respect to the opening, and in that the installation frame and the flap are each produced from plastic. The flap and the opening may have any desired form in respect of the cross-sectional area. By way of example, the flap and therefore also the opening can have a round or angular form.

Since the flap and the installation frame form a mounting unit produced from plastic, the mounting unit can easily be mounted in the plant and also be easily installed on site. If the flap and the shaft form one unit, the mounting unit is formed in two parts. One part is formed by the flap with the shaft, whereas the installation frame forms the second part.

The shaft and the flap can be formed in one piece, for example made of plastic. However, it is also entirely possible for two shaft stubs to be inserted into corresponding receptacles in the flap, the shaft stubs being arranged such that they cannot rotate with respect to the flap.

If the flap is connected to the installation frame by an axle, it is appropriate if a device for fixing the flap position is provided.

The installation frame can have a collar which partially surrounds the opening, in particular completely surrounds the opening, and is formed like a socket. The collar channels and supports the stream of air flowing through the opening in the region of the opening.

It is appropriate if the collar has a recess which receives the shaft or the axle in a latching manner at least in the region of one end of the shaft or of the axle. Thus, by way of example, the recess can taper towards its base, for example in the manner of a v, in which case the recess, at least in the region of one edge, has a protrusion which, in the latched state of the shaft or of the axle, prevents unintentional release of the shaft or of the axle from the recess.

At least one recess and that end of the shaft which interacts with this recess can be formed such that rotation prevention is provided in the form of an adhesion-improving surface, such as e.g. a coating, or a structure, such as e.g. fluting, such that self-latching adjustment is therefore possible. By way of example, the coating may be a rubber coating. On account of the self-latching adjustment, it is possible for the flap to be easily moved into the desired position during mounting.

An adjustment element for adjusting the flap position can be provided in the region of at least one end of the shaft. The flap is preferably fitted on site such that the adjustment element is accessible from the room, such that the flap position can therefore be changed at any time.

A partial region of the outer rim of the installation frame can have at least one mounting portion which is mounted articulatedly, in particular via a film hinge. Such a configuration is appropriate if the flap is used in a foldable connection box.

At least two pairs of clamping receptacles, preferably arranged in a distributed manner, for receiving a marginal region of an air-distributing element formed, in particular, in a funnel-like manner can be provided around the opening.

In a preferred embodiment of the invention, the installation frame extends substantially in one plane. Such a configuration is appropriate, in particular, for the use of connection boxes in which the housing-wall region into which the flap is to be inserted has a planar form.

The flap can have a multiplicity of, in particular round, through openings. It is appropriate if the free cross-sectional area formed by all the through openings is approximately between 20% and 80%, preferably approximately between 25% and 50%, and particularly preferably approximately 32%, with respect to the total area of the flap. Here, the diameter of a through opening can be between 3 mm and 6 mm, preferably 4 mm.

In this case, the through openings can be arranged distributed uniformly over at least a partial region of the area of the flap.

In order to keep the pressure loss in the region of the through opening as low as possible and to avoid the undesirable generation of noise, it is appropriate if at least one of the two circumferential edge regions of the rim of at least one through opening is rounded off and/or at least one of the two circumferential edge regions of the outer rim of the flap has a rounded off form. If, by way of example, the thickness of the flap is approximately 2.5 mm, it is appropriate if preferably both of the circumferential edge regions of the rim of at least one through opening have a rounded off form with a radius of between 0.5 mm and 1 mm, preferably with a radius of approximately 0.8 mm.

### BRIEF DESCRIPTION OF THE DRAWINGS

The text which follows explains exemplary embodiments of the invention which are shown in the drawings.

FIG. 1 is a plan view of a flap according to the invention,

FIG. 2 is a side view of the object according to FIG. 1,

FIG. 3 is a top view of the object according to FIG. 1,

FIG. 4 is an oblique side view of the object according to FIG. 1,

FIG. 5 shows the detail “X” from FIG. 4,

FIG. 6 shows the detail “Y” from FIG. 4,

FIG. 7 shows a section through a foldable connection box with a flap according to the invention,

FIG. 8 is an oblique view of a foldable connection box with a square outlet,

FIG. 9 shows the object according to FIG. 8 with a round outlet,

FIG. 10 is a plan view of a flap,

FIG. 11 is an oblique plan view of the object according to FIG. 10,

FIG. 12 shows a section through a flap in the region of a through opening,

FIG. 13 is an oblique plan view of a round connection box,

FIG. 14 is a side view of the object according to FIG. 13,

FIG. 15 is a top view of a flap according to the invention for a round connection box,

FIG. 16 is a side view of the object according to FIG. 15,

FIG. 17 is an oblique side view of the object according to FIG. 15,

FIG. 18 shows the object according to FIG. 15 with the flap inserted and the air-distributing element pushed on, and

FIG. 19 shows the object according to FIG. 18 in the disassembled state.

### DETAILED DESCRIPTION OF THE PREFERRED EMBODIMENT(S)

In all the figures, corresponding reference signs are used for identical or equivalent components.

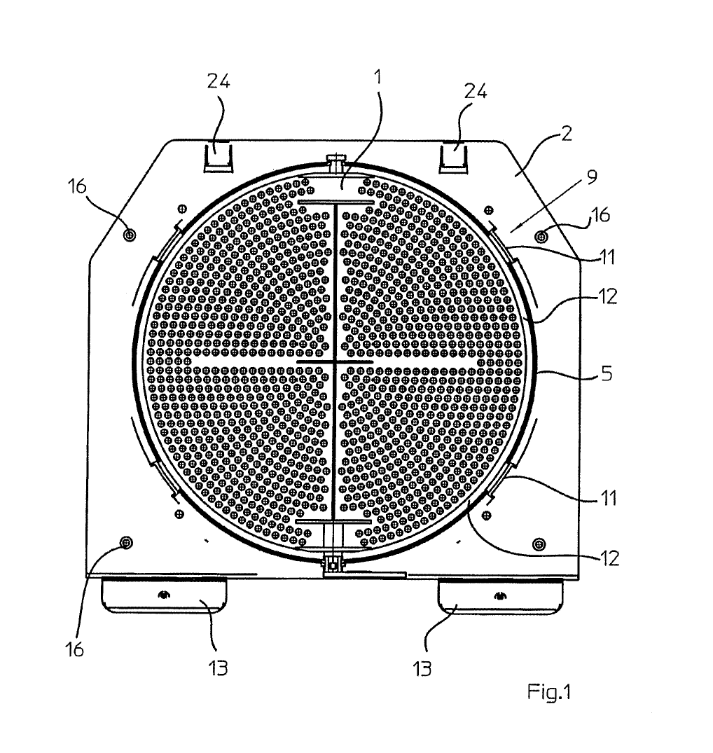

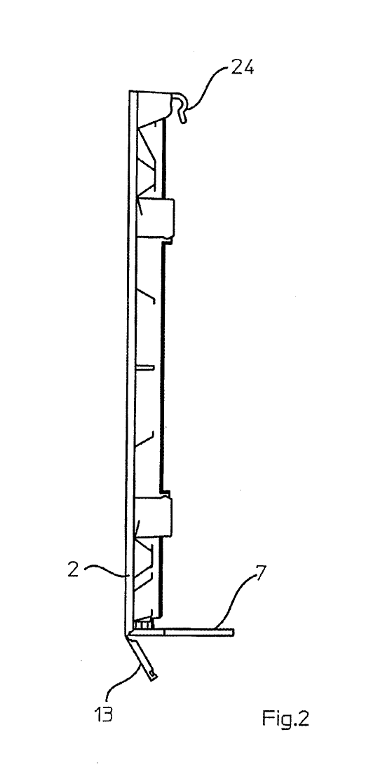

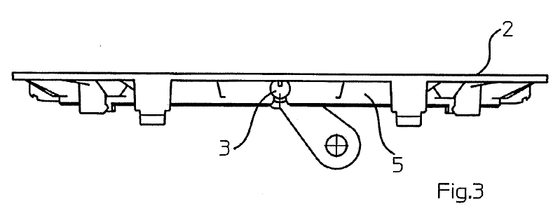

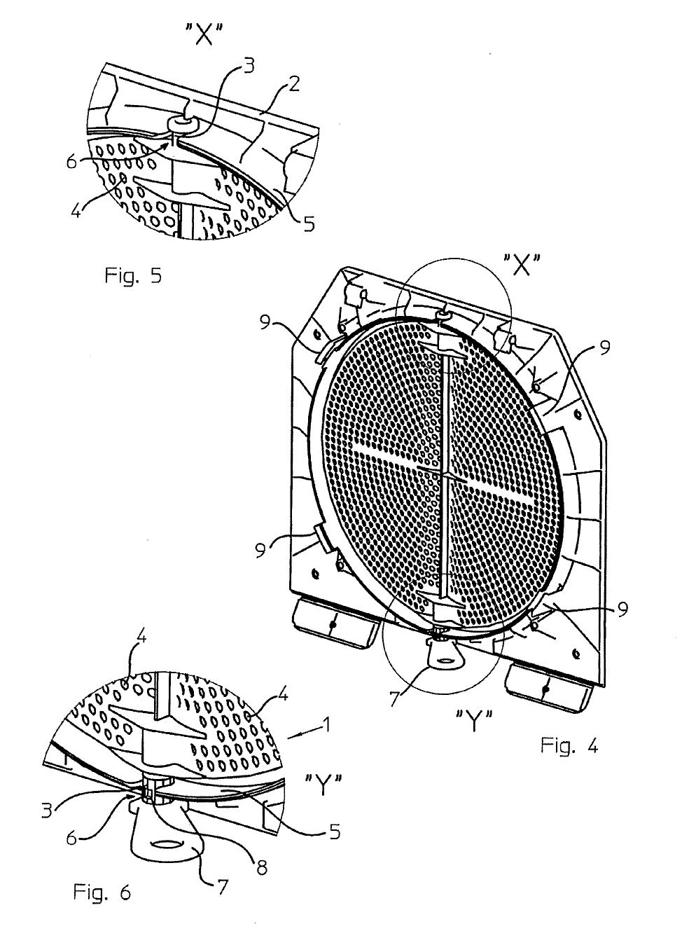

FIGS. 1 to 6 show a flap 1 in the form of a throttle flap, which is designed to influence a volumetric flow flowing in a ventilation and air-conditioning system.

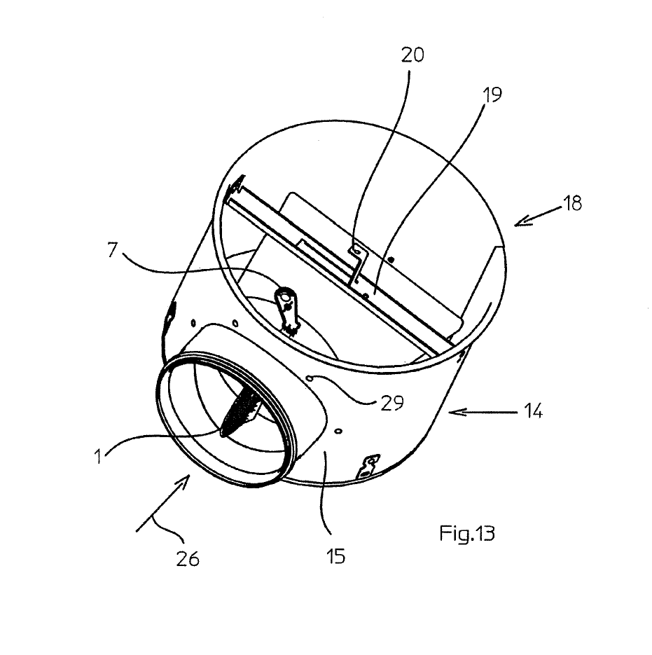

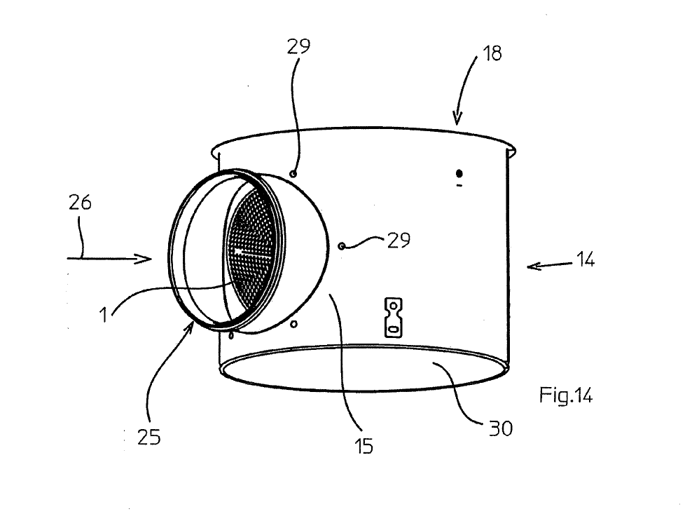

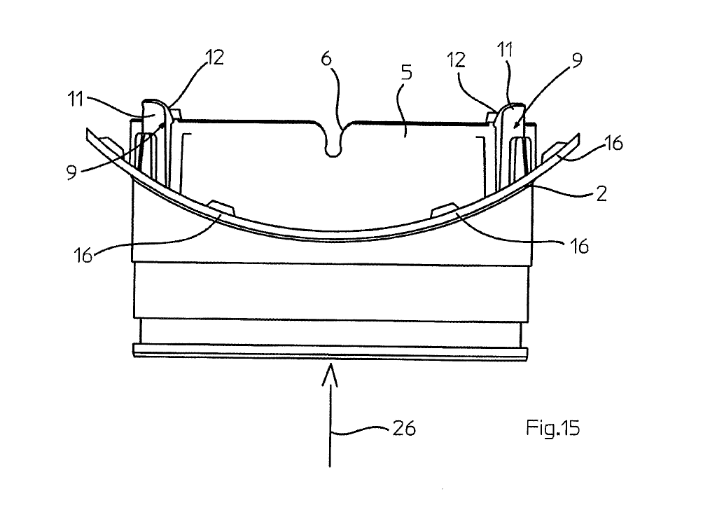

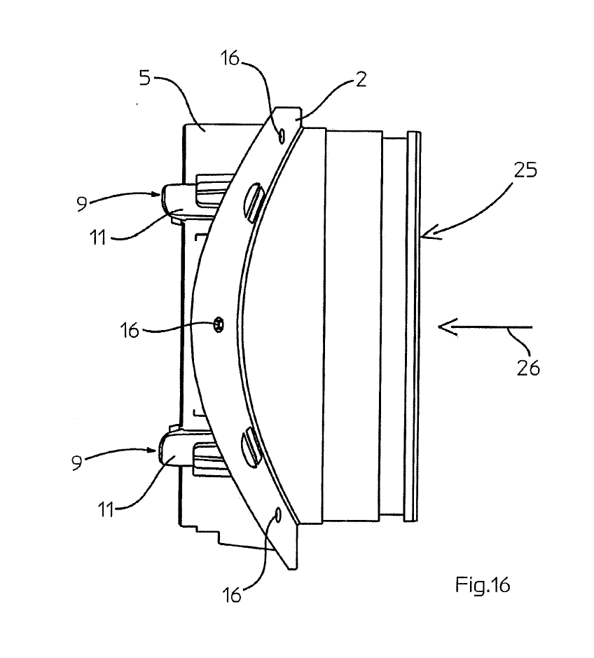

The flap 1 is arranged in an installation frame 2 having an opening, the installation frame 2 extending in one plane in the exemplary embodiment illustrated in FIGS. 1 to 6. In the exemplary embodiment illustrated in FIGS. 15 to 19, the installation frame 2 has a curved design, so that it can be used in a connection box 14 as illustrated in FIGS. 13 and 14.

The flap 1 and the installation frame 2 form a mounting unit. The flap 1 is mounted in the opening such that it can pivot about a shaft 3 arranged centrally with respect to the opening. The shaft 3 is fixed in terms of rotation with respect to the flap 1. The installation frame 2 and the flap 1 consist of plastic.

As can be gathered from the figures, the flap 1 has a multiplicity of round through openings 4, which are arranged distributed uniformly over partial regions of the area of the flap 1.

As can be gathered from FIGS. 5 and 6 or 15 and 16, for example, the installation frame 2 has a collar 5 which completely surrounds the opening and is formed like a socket. In order to mount the shaft 3, which is integrally formed on the flap 1, the collar 5 has in its opposing regions in each case one recess 6 which receives the shaft 3 in a latching manner, and therefore the flap 1 can be mounted in the installation frame 2 without the use of tools. Each latching recess 6 prevents the possibility of unintentional release of the shaft 3 from the recess 6.

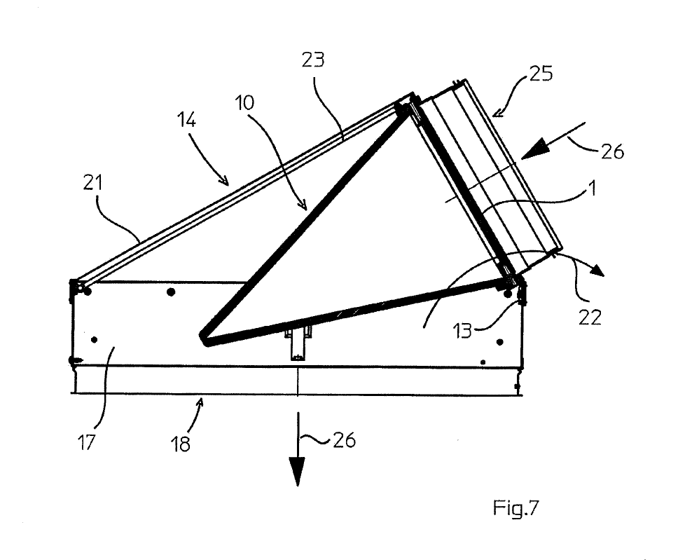

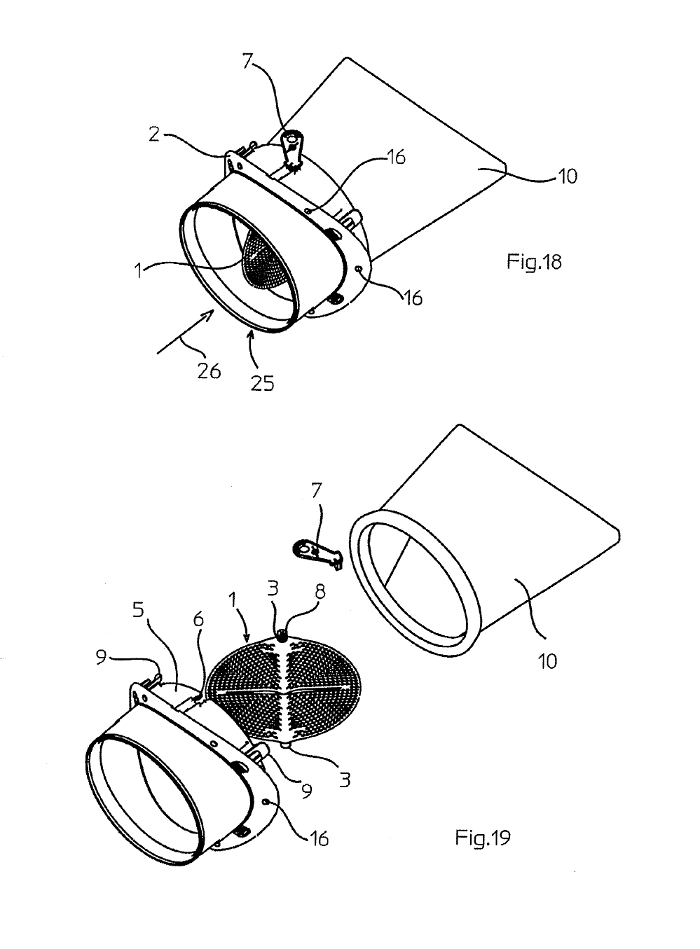

At the lower end of the shaft 3, as illustrated in FIG. 1 or 6, or at the upper end of the shaft 3, as illustrated in FIGS. 13 and 18, provision is made of an adjustment element 7 in the form of a lever, in order that the position of the flap 1 can be set. In order to prevent the flap position from being changed unintentionally, in relation to the exemplary embodiment illustrated in FIG. 1 or 6, the lower recess 6 and that end of the shaft 3 which interacts with the recess 6 are formed such that rotation prevention is provided in the form of a structure. In this exemplary embodiment illustrated, the lower end of the shaft 3 is not round, but instead has a structure in the form of partial areas 8 which are arranged distributed at an angle with respect to one another over the circumference of the shaft 3. The corresponding recess 6 is formed in an appropriate manner.

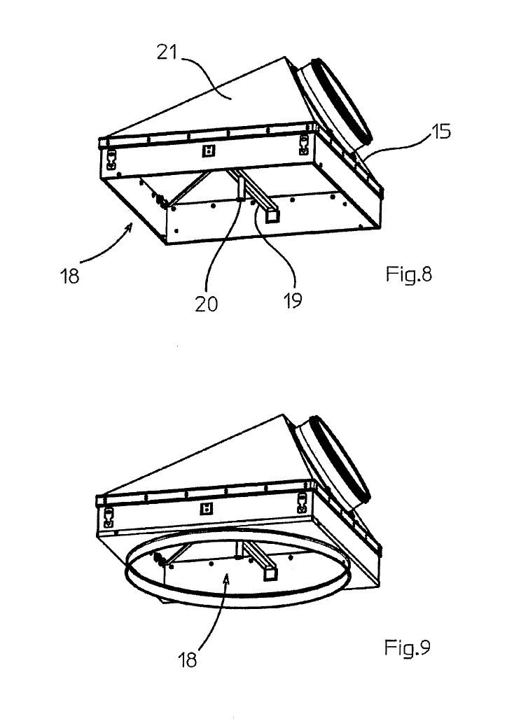

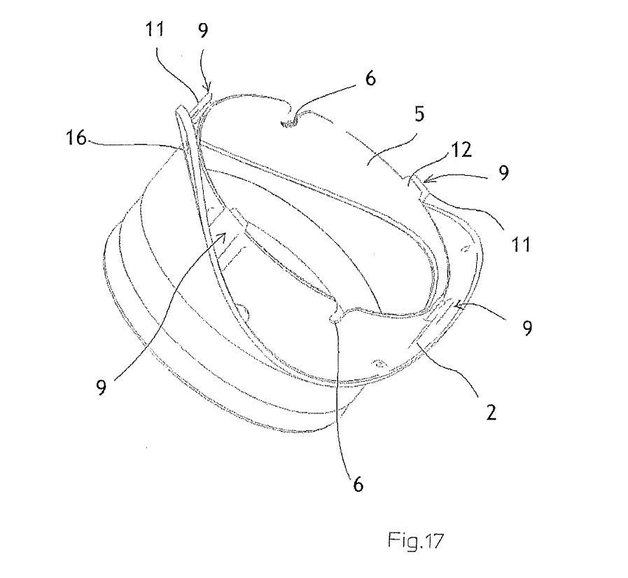

As can be gathered from FIG. 1 or FIG. 17, four pairs of clamping receptacles 9 which are arranged at an angle of 90° with respect to one another and are intended for receiving a marginal region of an air-distributing element 10 formed in a funnel-like manner, as illustrated in FIGS. 7, 18 and 19, are provided around the opening, such that the air-distributing element 10 can be mounted on the installation frame 2 by being pushed on without the use of tools.

Each clamping receptacle 9 consists of two portions 11, 12 which are arranged parallel to one another and form between them a clamping gap, in which the circumferential rim of the air-distributing element 10 is fixed. As can be gathered from FIG. 1 or FIG. 15, for example, in the exemplary embodiment illustrated that portion 12 of each clamping receptacle 9 which faces toward the opening is formed by the collar 5 itself.

As can be gathered from FIG. 1, the outer rim of the installation frame 2 has two mounting portions 13, which are connected articulatedly to the installation frame 2 via a respective film hinge. These mounting portions 13 serve for mounting the installation frame 2 on a foldable connection box 14, which is illustrated inter alia in FIG. 7. As can be gathered from FIG. 7, the housing-wall region 15 in which the installation frame 2 is mounted has a planar form. Bores 16 are provided in the installation frame 2 for fastening purposes.

FIGS. 7 to 9 illustrate a foldable connection box 14. This consists of a circumferential frame 17, which is made of sheet metal and has an outlet 18 on the underside. A front panel (not illustrated) is mounted in the region of this outlet 18. For mounting purposes, provision is made of a crosspiece 19 having a central bore 20, into which a corresponding screw can be screwed. The outlet 18 is square in the exemplary embodiment illustrated in FIG. 8 and round in FIG. 9.

The three further housing-wall regions 21 which form the wall between the installation frame 2 and the frame 17 consist of a flexible, air-impermeable material. During mounting, the housing-wall region 15 is pivoted up with the flap 1 in the direction of the arrow 22. As soon as the housing-wall region 15 having the flap 1 has reached its operating position, illustrated in FIG. 7, the housing-wall region 15 is fixed by way of a supporting rod 23. One end of the supporting rod 23 is fastened rotatably to the frame 17, while the other end can be latched into a corresponding latching receptacle 24 of the installation frame 2.

As can be gathered from the sectional illustration in FIG. 7, the flap according to the invention is mounted in an inlet 25 in the connection box 14. The mounting portions 13 of the installation frame 2 are in this case fastened to the circumferential frame 17 by way of screws (not illustrated in more detail).

In order to distribute the air flowing in the direction of the arrow 26, the air-distributing element 10 already mentioned is provided on that side of the installation frame 2 which is remote from the stream of air, said air-distributing element, in the exemplary embodiment illustrated, being formed in a funnel-like or conical manner and consisting of an air-permeable fabric, such as a fibrous nonwoven web. In the region of the open end, the air-distributing element 10 has an encircling ring, which is plugged into the four clamping receptacles 9.

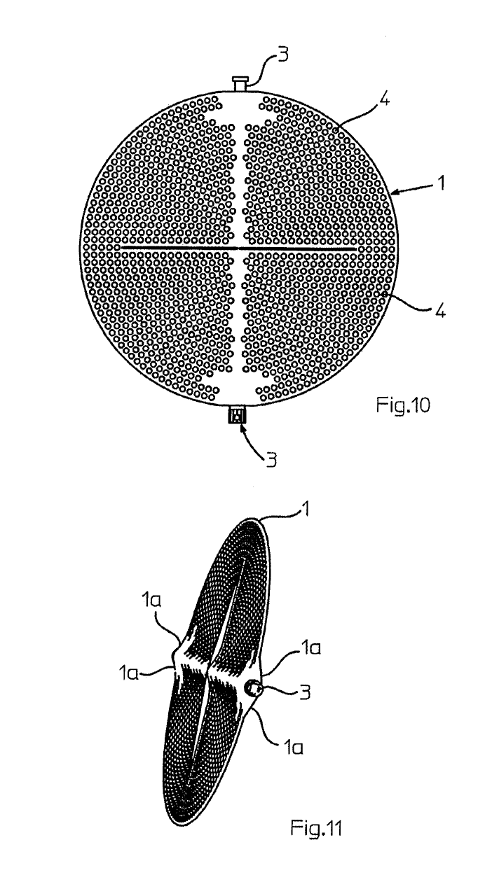

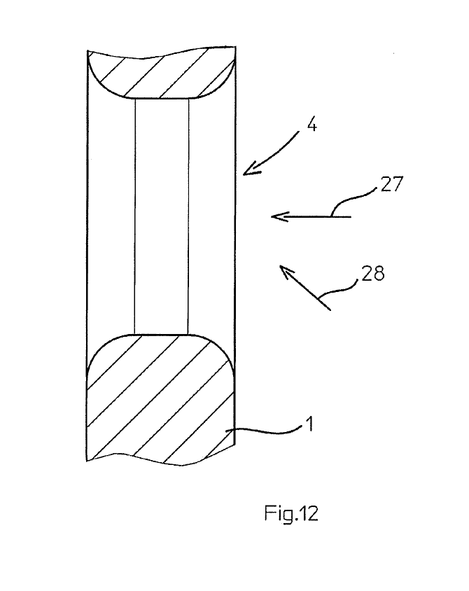

FIGS. 10 and 11 also illustrate, in detail, a flap 1 having the multiplicity of through openings 4, which are arranged distributed uniformly over partial regions of the area of the flap 1. As can be gathered from FIG. 12, the two circumferential edge regions of the rim of the through opening 4 illustrated have a rounded off form with a radius of approximately 0.8 mm. The thickness of the flap 1 is approximately 2.5 mm. Therefore, the through opening 4 is formed like a nozzle and is optimized in relation to flow and in relation to acoustics both in the case of a straight incident flow (arrow 27) and in the case of transverse flow (arrow 28).

As can be gathered from FIG. 11, the shaft 3 lies in the plane of the flap 1. In order to optimize the flow-related properties, the flap regions 1 a which extend on both sides along the shaft 3 on both sides of the flap are therefore formed in a curved manner with a gradient in the direction of the shaft 3.

FIGS. 13 and 14 illustrate a round connection box 14, such that the housing-wall region 15 in which the installation frame 2 is mounted has a round form. In terms of its curvature, the installation frame 2 is matched to the diameter of the connection box 14. The installation frame 2 is fastened to the inside of the housing-wall region 15 by means of screws 29.

The connection box 14 has a closed base 30, and the outlet 18 is arranged so as to lie opposite said base. A front panel (not illustrated) is mounted in the region of the outlet 18. For the mounting, provision is made in turn of a crosspiece 19 having a central bore 20, into which a corresponding screw can be screwed.

FIGS. 15 to 19 illustrate a mounting unit consisting of the flap 1 and the installation frame 2 for use in a round connection box 14 according to FIGS. 13 and 14.

As can be gathered from FIGS. 18 and 19, in order to distribute the air flowing in the direction of the arrow 26, the air-distributing element 10 already mentioned is provided on that side of the installation frame 2 which is remote from the stream of air, said air-distributing element, in the exemplary embodiment illustrated, being formed in a funnel-like or conical manner and consisting of an air-permeable fabric, such as a fibrous nonwoven web. In the region of the open end, the air-distributing element 10 has the encircling ring, which is plugged into the four clamping receptacles 9.

Instead of the shaft 3, it is of course also possible to provide an axle, in which case a separate device for fixing the flap position is then required.

We claim:

1. Flap (1), in particular a throttle flap, for influencing a volumetric flow flowing in a ventilation and air-conditioning system, characterized in that the flap (1) is arranged in an installation frame (2) having an opening, and in that the flap (1) and the installation frame (2) form a mounting unit, wherein the flap (1) is mounted in the opening such that it can pivot about a shaft (3) or axle arranged centrally, in particular, with respect to the opening, and in that the installation frame (2) and the flap (1) are each produced from plastic.

2. Flap (1) according to claim 1, characterized in that the installation frame (2) has a collar (5) which partially surrounds the opening, in particular completely surrounds the opening, and is formed like a socket.

3. Flap (1) according to claim 2, characterized in that the collar (5) has a recess (6) which receives the shaft (3) or the axle in a latching manner at least in the region of one end of the shaft (3) or of the axle.

4. Flap (1) according to claim 3, characterized in that at least one recess (6) and that end of the shaft (3) which interacts with this recess (6) are formed such that rotation prevention is provided in the form of an adhesion-improving surface, such as e.g. a coating, or a structure, such as e.g. fluting.

5. Flap (1) according to claim 1, characterized in that an adjustment element (7) for adjusting the flap position is provided in the region of at least one end of the shaft (3).

6. Flap (1) according to claim 1, characterized in that a partial region of the outer rim of the installation frame (2) has at least one mounting portion (13) which is mounted articulatedly, in particular via a film hinge.

7. Flap (1) according to claim 1, characterized in that at least two pairs of clamping receptacles (9) arranged in a distributed manner for receiving a marginal region of an air-distributing element (10) formed in a funnel-like manner are provided around the opening.

8. Flap (1) according to claim 1, characterized in that the installation frame (2) extends substantially in one plane.

9. Flap (1) according to claim 1, characterized in that the flap (1) has a multiplicity of in particular round, through openings (4).

10. Flap (1) according to claim 1, characterized in that the through openings (4) are arranged distributed uniformly over at least a partial region of the area of the flap (1).

11. Flap (1) according to claim 1, characterized in that at least one of the two circumferential edge regions of the rim of at least one through opening (4) is rounded off.

12. Flap (1) according to claim 1, characterized in that at least one of the two circumferential edge regions of the outer rim of the flap (1) has a rounded off form.

13. Flap (1) according to claim 2 characterized in that an adjustment element (7) for adjusting the flap position is provided in the region of at least one end of the shaft (3).

14. Flap (1) according to claim 3, characterized in that an adjustment element (7) for adjusting the flap position is provided in the region of at least one end of the shaft (3).

15. Flap (1) according to claim 4 characterized in that an adjustment element (7) for adjusting the flap position is provided in the region of at least one end of the shaft (3).

16. Flap (1) according to claim 2, characterized in that a partial region of the outer rim of the installation frame (2) has at least one mounting portion (13) which is mounted articulatedly, in particular via a film hinge.

17. Flap (1) according to claim 3, characterized in that a partial region of the outer rim of the installation frame (2) has at least one mounting portion (13) which is mounted articulatedly, in particular via a film hinge.

18. Flap (1) according to claim 4, characterized in that a partial region of the outer rim of the installation frame (2) has at least one mounting portion (13) which is mounted articulatedly, in particular via a film hinge.

19. Flap (1) according to claim 5, characterized in that a partial region of the outer rim of the installation frame (2) has at least one mounting portion (13) which is mounted articulatedly, in particular via a film hinge.

20. Flap (1) according to claim 2, characterized in that at least two pairs of clamping receptacles (9) arranged in a distributed manner for receiving a marginal region of an air-distributing element (10) formed in a funnel-like manner are provided around the opening.
